(19) United States
(12) Patent Application Publication
(10) Pub. No.: US 2010/0235870 A1
(43) Pub. Date: Sep. 16, 2010

(54) SYSTEM AND METHOD FOR PUSHING VIDEO ON DEMAND CONTENT BASED UPON VIEWING HABITS

(76) Inventors: Jade D. Kerr, Kansas City, MO (US); Michael P. Morrissey, Overland Park, KS (US); Andrew V. Cook, Lenexa, KS (US); Clinton J. Smoyer, Raymore, MO (US); Mohit Mathur, Olathe, KS (US)

Correspondence Address: Woodard, Emhardt, Moriarty, McNett & Henry LLP, 111 Monument Circle, Suite 3700, Indianapolis, IN, 46204-5137, US

(21) Appl. No.: 12/402,212

(22) Filed: Mar. 11, 2009

(51) Int. Cl. H04N 7/173; H04N 7/26

(52) U.S. Cl. 725/97; 386/124; 386/E05.001

(57) ABSTRACT

A system and method for delivering video content over a network comprises providing a network server and a database, receiving a request for video content at the network server, querying the database to determine subscribers likely interested in the video content, and delivering the video content to network devices associated with subscribers likely interested in the video content. The database stores data associated with the viewing habits of network subscribers. The querying step results in the identification of a subset of subscribers likely interested in the video content.

### BACKGROUND

As technology has developed, so have the ways in which viewers obtain video content. Not long ago, viewers could either watch video broadcast to their television sets or by traveling to the local cinema to watch a motion picture. VHS tapes and DVDs eventually emerged, both of which allowed viewers to watch the video content whenever they chose.

With the development of Internet protocol television (IPTV), communication companies are establishing networks for subscribers to watch video content. Generally, IPTV describes a system where a digital television service is delivered using Internet protocol (IP) over a network. The network used for IPTV may include the public Internet or a private IP network controlled by an IPTV service provider via a broadband connection known as digital subscriber lines (DSL), where a digital subscriber line typically includes conventional telephone lines with copper wire into households. Alternatively, the digital subscriber may be fiber to the premises (FTTP). Telecommunication service provider companies that have begun offering DSL have limited bandwidth resources, particularly when delivering video over existing copper wire infrastructures.

In additional to television programming, many communications companies offer their subscribers video on demand (VOD) services. FIG. 1 is an illustration of a conventional system 100 that is configured to deliver VOD. As shown, a provider 102 is communicatively connected to a head-end server 106. Server 106 is used to store video content delivered to it from service provider 102. The server 106 is also capable of delivering video content 104 over a network 108, such as the internet or public/private packet switched network (PSN), for example. As shown, server 106 is configured to transmit video content in the form of data packets 104. The server 106 delivers the video content 104 via the network 108 to a DSL access multiplexer (DSLAM) 110. The DSLAM 110 operates to connect subscribers to the network 108, host video streams/Internet group management protocol (IGMP), and provide Ethernet transport of the video content. The DSLAM 110 further operates as a multiplexer to distribute the video content 104 through communication lines 112a-112n to set top boxes (STB) 114a-114n (collectively 114). Additionally, the DSLAM 110 may also communicate VOD requests from a particular STB 114 to the server 106 via network 108.

Today, VOD typically exists as a unicast video stream, as illustrated in FIG. 1. In a unicast stream set-up, there is one video stream for each subscriber requesting the video content. Therefore, if 100 subscribers request to receive a particular video file, 100 distinct copies of the video are delivered through the system. As shown in FIG. 1, STB A 114a initiated the request for video 104. After STB A 114a requested the video, server 106 initiated the delivery through network 108 and to STB A 114a. As shown, STBs B-N 114b-n did not receive the video. However, if STB B 114b requested the same video only moments after STB A 114a, duplicate copies of the video content 104 would simultaneously be streamed through the network 108. As can be appreciated, delivering video through a unicast video stream can bombard systems and dramatically reduce available system bandwidth when multiple subscribers request video content.

Therefore, service providers are beginning to offer video content through a multicast video stream. A multicast video stream is illustrated in FIG. 2. Multicast stream network 200 is similar in most respects to unicast system 100. However, in contrast to the unicast video stream, multicast video streams are delivered to all subscribers connected to the network. As shown in FIG. 2, video 104 is delivered to all STBs 114a-n. In some versions of multicast VOD systems, multiple copies of the same video content are streamed through the network beginning at various intervals (e.g., every 15 minutes). This allows a video service provider to limit the number of video streams for particular video content, thereby limiting the amount of bandwidth dedicated to that video. However, multicast streaming requires the subscribers interested in the video content to begin watching the video content at a set time or at set intervals, which undermines the “on demand” aspect of VOD.

Additionally, electronic devices exist on the market that allow users to record video content based on the user's selection criteria. Digital video recorders (DVRs) allow consumers to record digital video content, such as video 104. Some service providers provide as an option to their subscribers the opportunity to lease a DVR from the provider, as opposed to the subscribers purchasing their own.

In light of the above, there exists a need for a system that provides true VOD while minimizing traffic on the network.

### SUMMARY

The present invention provides an improved VOD system and method. The claims, and only the claims, define the invention.

To provide true VOD while minimizing traffic on the network, the principles of the present disclosure provide a system and method that leverages existing video traffic on the network by sending VOD streams to additional subscribers based on past viewing habits. The STBs associated with the additional subscribers may then store the VOD content, allowing the recipient to watch the video at his or her leisure without generating additional traffic on the network.

In one aspect of the present disclosure, a method for delivering video content over a network comprises providing a network server and a database, receiving a request for video content at the network server, querying the database to determine subscribers likely interested in the video content, and delivering the video content to network devices associated with subscribers likely interested in the video content. The database stores data associated with the viewing habits of network subscribers. The querying step results in the identification of a subset of subscribers likely interested in the video content.

It is an object of certain embodiments of the present disclosure is to provide an improved VOD system and method.

Further, objectives and advantages of the present invention will appear as the description proceeds.

### BRIEF DESCRIPTION OF THE DRAWINGS

FIG. 1 is an illustration of a conventional system configured to deliver VOD via a unicast stream.

FIG. 2 is an illustration of a conventional system configured to deliver VOD via a multicast stream.

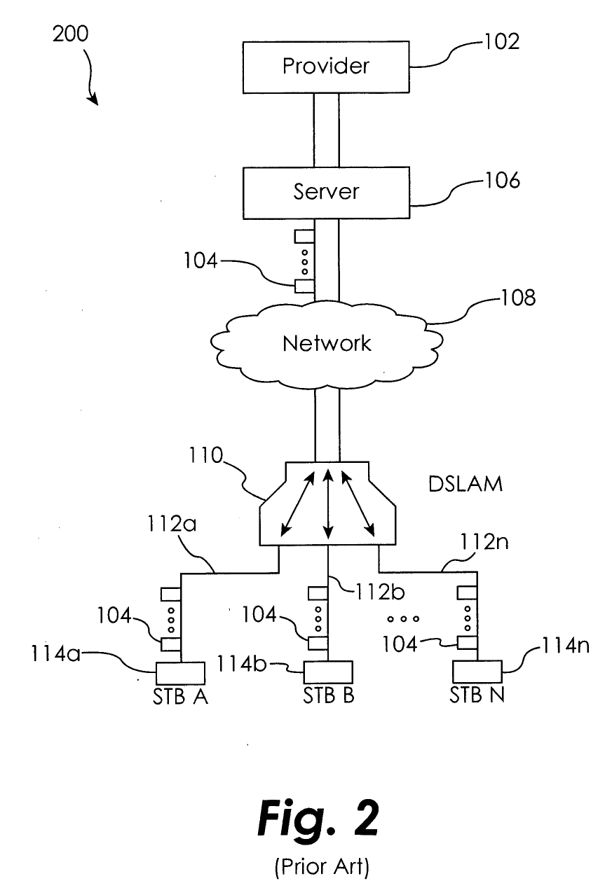

FIG. 3 is an illustration of an exemplary system configured to deliver VOD in accordance with the principles of the present disclosure.

FIG. 4 is a block diagram of an exemplary device utilized to deliver video content to a subscriber.

FIG. 5 is a signal diagram of an exemplary process for delivering VOD to a subscriber.

FIG. 6 is a flow chart for network operation for delivering VOD to a subscriber.

### BRIEF DESCRIPTION OF THE PREFERRED EMBODIMENTS

For the purposes of promoting an understanding of the principles of the invention, reference will now be made to the embodiments illustrated herein and specific language will be used to describe the same. It will nevertheless be understood that no limitation of the scope of the invention is thereby intended. Such alterations and further modifications in the described processes, systems or devices, any further applications of the principles of the invention as described herein, are contemplated as would normally occur to one skilled in the art to which the invention relates, now and/or in the future.

The language used in the claims is to only have its plain and ordinary meaning, except as may be explicitly defined herein. Such plain and ordinary meaning is inclusive of all consistent dictionary definitions from the most recently published Webster's dictionaries and Random House dictionaries.

The principles of the present disclosure provide a system and method that leverages existing video traffic on the network by sending VOD streams to subscribers in addition to the requesting subscriber based on past subscriber viewing habits. The set top boxes associated with the additional subscribers may then store the VOD content, which allows the recipient to watch the video content at his or her leisure without generating additional traffic on the network.

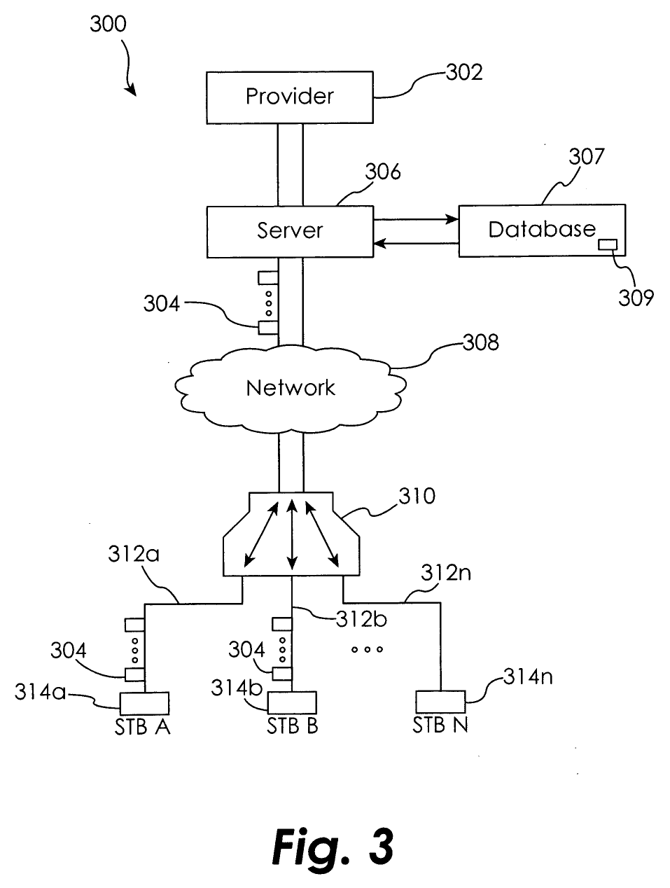

FIG. 3 is an illustration of an exemplary network 300 configured to deliver VOD content to network subscribers in accordance with the principles of the present disclosure. As shown, a provider 302 is communicatively connected to a head-end server 306, which is communicatively connected to a database 307. A processor 309 is communicatively connected with database 307. Server 306 is used to store video content delivered, transferred and/or uploaded to it from provider 302. The server 306 is also capable of delivering video content 304 over a network 308, such as the internet or public/private packet switched network (PSN), for example. As shown, server 306 is configured to transmit video content in the form of data packets 304. The server 306 delivers the video content 304 via the network 308 to a DSL access multiplexer (DSLAM) 310. The DSLAM 310 operates to connect subscribers to the network 308, host video streams/Internet group management protocol (IGMP), and provide Ethernet transport of the video content. The DSLAM 310 further operates as a multiplexer to distribute the video 304 through communication lines 312a-312n to set top boxes (STB) 314a-314n (collectively 314). Additionally, the DSLAM 310 may also communicate VOD requests from a particular STB 314 to the server 306 via network 308.

As previously noted, network 300 includes database 307 and processor 309. Database 307 may be configured to maintain subscriber activity data of the STBs 314 connected to network 308. More particularly, database 307 may maintain data related to the VOD viewing habits of the subscriber's associated with network 308. In one embodiment, the subscriber activity data may be directly gathered from VOD requests being transmitted to server 306. In another embodiment, the data may be collected through another means and then transferred or uploaded onto the database 307.

Database 307 may be configured to receive information related to particular video content from server 306. Some aspects of the present disclosure will be explained through the use of an example. For instance, subscriber B. Wayne may wish to watch a particular video, such as “The Dark Knight,” through his provider's VOD service. B. Wayne will use STB A 314a to initiate his request, which will travel through communication line 312a to DSLAM 310. DSLAM 310 then transmits the request to server 306 through network 308. In one embodiment, the server 306 transmits video information related to “The Dark Knight,” such as title, genre, rating, release date, cast, director, producer, etc. The database 307 may be configured to receive the video information from server 306. Associated processor 309 may then process the subscriber activity data with respect to the video information (e.g. determine and record that subscriber B. Wayne has an affinity for video content related to the video information). Processor 309 may be configured to identify additional subscribers within the network 308 determined to likely make a VOD request for the particular video content. Processor 309 may be provided within database 307 (as shown) or maintained separately from database 307. Once the subscriber activity data has been processed, processor 309 may deliver the results back to database 307 or server 306. In one embodiment, processor 309 may generate a list of subscribers likely interested in the video content.

Returning to the example, database 307 will receive information related to “The Dark Knight,” such as genre: action, rating: PG-13, and release date: Dec. 8, 2008. The database 307 may provide this information to processor 309 which may then process this information through known alrogrithms, processes and/or metrics to determine other viewers that will likely request “The Dark Knight” through VOD. Subscriber H. Dent, for example, may consistently request VOD related to new release, action movies. Another subscriber, A. Pennyworth, may often request comedy films released in the 1980s. In this instance, processor 309 may identify H. Dent as potentially interested in “The Dark Knight.” Accordingly, database 307 or processor 309 may transmit a list identifying H. Dent as potentially interested in “The Dark Knight” to server 306.

As noted above, server 306 is configured to stream video content to STBs 314 associated with network 308. Upon receipt of the list of additional subscribers, server 306 may be configured to both deliver the video content to (1) the initial requester of the video and (2) the additional subscribers indicated by database 307 as being likely interested. In one embodiment, server 306 may “push” the particular video content to the STB associated with potentially interested subscribers. As used herein, the term “push” means that the video content will be stored either on the STB or on any other memory device, such as an associated external DVR.

In the above example, B. Wayne will receive and watch “The Dark Knight” just like any other VOD request. However, server 306 will also send “The Dark Knight” to H. Dent, and more particularly to STB B 314b, via multicast stream. In one embodiment, server 306 instructs video 304 to be stored on STB B 314b. In one version, H. Dent may then be notified that “The Dark Knight” is ready for immediate viewing. Provider 302 may also allow this “pushed” video content to be viewed by the additional subscribers at a reduced rate. Later, if H. Dent elects to view “The Dark Knight,” it will play directly off of STB B 314b, instead of being streamed from server 306. Therefore, an additional subscriber gets to view the video content with no additional traffic on the network.

In another embodiment, subscribers may be given the choice by their service providers to opt-in to the system presently disclosed herein. Database 307 may maintain information regarding those subscribers would like video content to be pushed to their STBs. Additionally, each subscriber may manage the frequency in which video content is pushed to his/her STB. For example, one subscriber may allow up to two videos to be pushed to his STB per week while another subscriber may only allow one video to be pushed to her STB per month. Due to STB memory constraints, the server 306 may check for available memory capacity on the additional subscriber's STB. In one form, old video content may be deleted if there is not sufficient memory available on the subscriber's STB for the new, pushed video content. In another embodiment, the server 306 will not push the new video content and the subscriber will be notified that additional video content could not be pushed for lack of STB memory. It is further contemplated that the STB has memory dedicated for pushed video content.

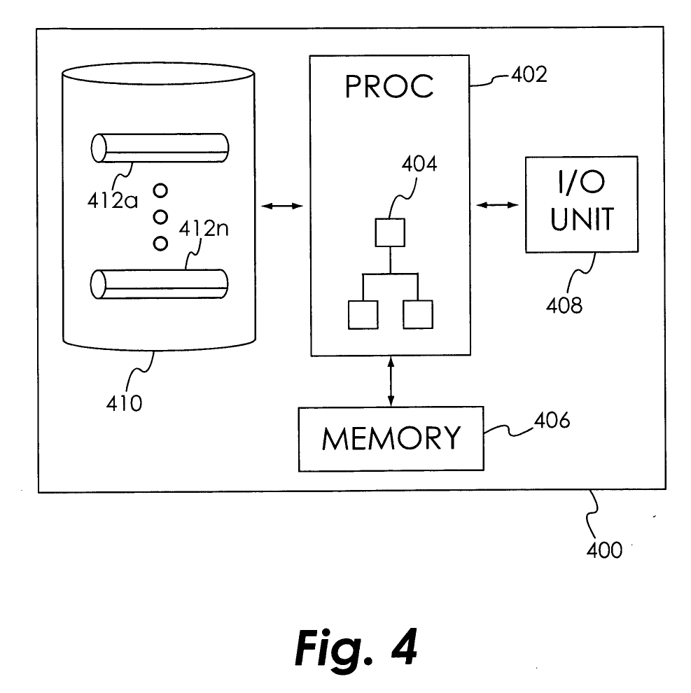

FIG. 4 is a block diagram of an exemplary system 400 device utilized to deliver video content to an end-user (e.g., subscriber). The system 400 may be generally representative of a number of systems utilized to deliver video content associated therewith to end-users. For example, the system 400 may represent a head-end server 306 and/or set top box 314. As shown, the device 400 includes a processing unit 402, which may be formed of one or more processors, that executes software 404. The software, depending upon the system functionality, may be configured to store and (i) manage information, such as video content, (ii) manage routing of video streams, or (iii) manage interaction with an end-user to download video programming and images for display on a television or other electronic display.

The processing unit 402 may be in communication with a memory 406. The memory 406 may be a random access memory, flash memory, or any other memory type. The processing unit 402 may also be in communication with an input/output (I/O) unit 408 that is configured to communicate with a television or other electronic display, remote control, network, or other devices, such as digital video disc (DVD), digital video recorder (DVR), or any other local or network located device. The processing unit 402 may additionally be in communication with a storage unit 410 that is configured to store video data files in data repositories 412a-412n (collectively 412).

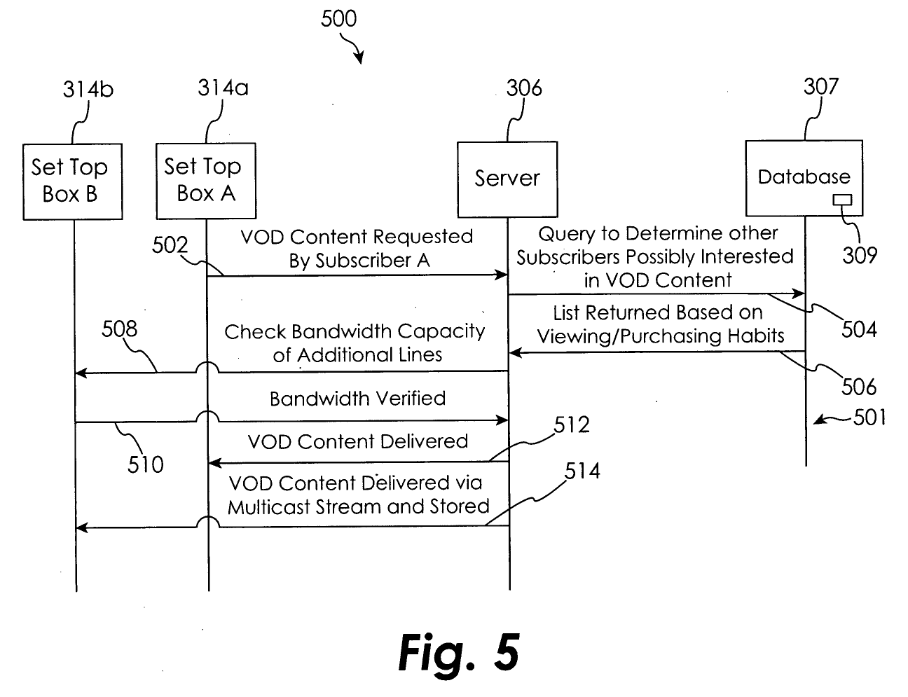

FIG. 5 is a signal diagram illustrating an exemplary process 500 for delivering VOD to subscribers. Five different devices are shown, including server 306, database 307, processor 309 and STBs A and B 314a, 314b. Signals 501 may be communicated between each of the devices. At step 502, a request for VOD content may be communicated from STB A 314a to server 306. The server 306 may then query database 307 to determine additional subscribers likely interested in the VOD content (step 504). In response, database 307 returns a list of additional subscribers identified by processor 309 as likely to request the VOD content (step 506). In another embodiment, processor 309 may directly return the list of additional subscribers identified as likely to request the VOD content. The list of additional subscribers is based on a log of the past VOD viewing habits of network subscribers. As shown, the subscriber associated with STB B 314b is identified. Based upon the available VOD viewing history, processor 309 may ascertain other subscribers who may be interested in the VOD content through processes, algorithms, and/or metrics known in the art.

After receiving the list of additional subscribers likely interested in the VOD content, the server 306 may check for available bandwidth capacity on the additional subscriber's lines (step 508). In another form, the server 306 may check for available memory capacity on the additional subscriber's STB (not shown). At step 510, the available bandwidth capacity on the line associated with STB B 314b is verified. At step 512, the VOD content is delivered from server 306 to the initial requester via multicast stream. At step 514, the multicast stream also delivers the VOD content to the additional subscribers indicated by database 307 as potentially interested in the VOD content. As the VOD content arrives, STB B 314b stores the VOD content for future viewing.

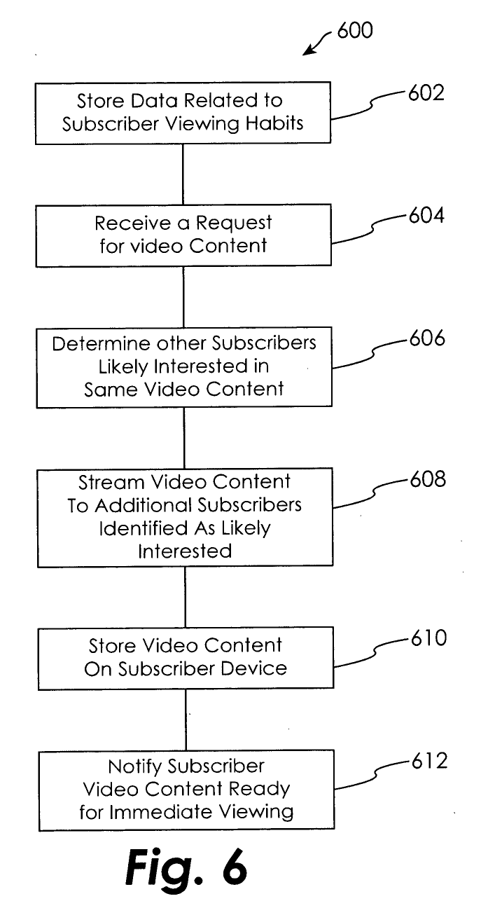

FIG. 6 is a flow chart of an exemplary process 600 for system operation for delivering VOD to subscribers. The process 600 starts at step 602, where data is stored related to the viewing habits of subscribers within the network. At step 604, a request for video content is received at a first network device. The first network device may be a server. At step 606, a second network device determines other subscribers within the network that are likely interested in the same video content. The second network device may be a database with an associated processor. The second network device determines the other interested subscribers through processes, algorithms, and/or metrics known in the art. At step 608, the video content is streamed to the additional subscribers. The video is also delivered to the subscriber who originally made the request for the video content. The video content may be streamed through a multicast video stream. At step 610, the video content is stored on an electric device of the end user. In one embodiment, the electronic device may be a STB. In another embodiment, the electronic device may be a DVR.

At step 612, the STB may notify the subscriber that the VOD content is available for immediate viewing. Optionally, the network may allow the subscriber to view the “pushed” VOD content at a reduced rate.

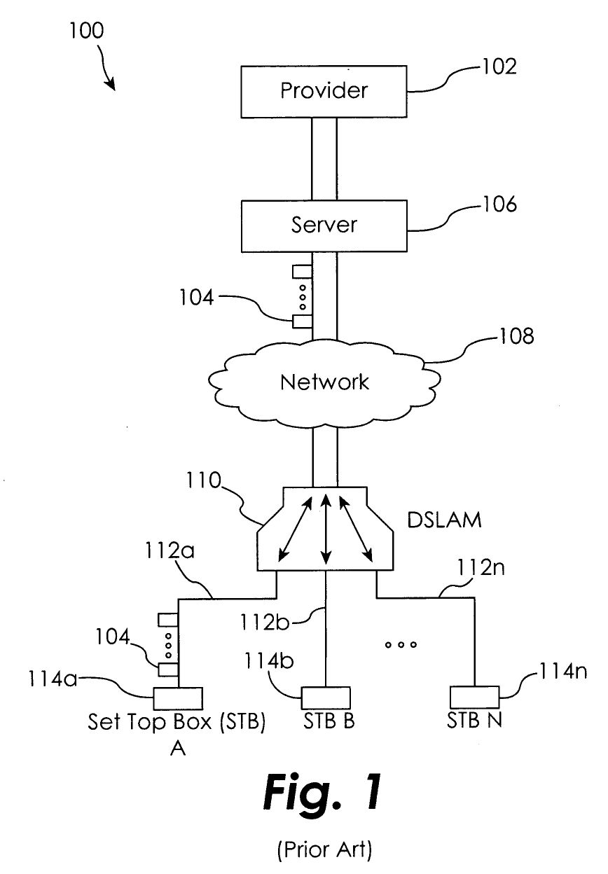

In one embodiment, the disclosed methodology is limited to those STBs leased by the provider to the subscribers. Accordingly, server 306 may verify that STBs 314 of FIG. 1 are the property of the provider 302 instead of the individual subscriber.

Although the principles of the present disclosure have been described in association with set top boxes, it should be understood that the set top box functionality may be incorporated into a television or network and use the principles of the present disclosure in the same or similar manner.

While the invention has been illustrated and described in detail in the drawings and foregoing description, the same is to be considered as illustrative and not restrictive in character, it being understood that only the preferred embodiments have been shown and described and that all changes and modifications that come within the spirit of the invention are desired to be protected. It is also contemplated that structures and features embodied in the present examples can be altered, rearranged, substituted, deleted, duplicated, combined, or added to each other. The articles “the”, “a” and “an” are not necessarily limited to mean only one, but rather are inclusive and open ended so as to include, optionally, multiple such elements.

What is claimed is:

1. A method of delivering video content over a network in communication with a plurality of subscribers each having an associated network device, said method comprising the steps of:
providing a network server and a database, said database storing data associated with the viewing habits of said subscribers,
receiving a request for said video content at said network server;
querying said database to determine subscribers likely interested in said video content, said querying step resulting in the identification of a subset of said subscribers likely interested in said video content; and
delivering said video content to said network devices associated with said subset of said subscribers.

2. The method of claim 1 further comprising the step of processing said data with respect to information related said video content.

3. The method of claim 2, wherein said information is selected from the group consisting of title, genre, rating, release date, cast, director and producer.

4. The method of claim 2, wherein said processing step results in a list identifying said subset.

5. The method of claim 4 further comprising the step of delivering said list from said database to said server.

6. The method of claim 1 further comprising the step of verifying the available bandwidth capacity of the communication lines associated with said subset of said subscribers.

7. The method of claim 1 further comprising the step of storing the video content on said network devices associated with said subset of said subscribers.

8. The method of claim 7 further comprising the step of notifying said subset of said subscribers that said video content is ready for immediate viewing.

9. The method of claim 7, wherein said network device is a DVR.

10. The method of claim 9 further comprising the step of verifying said DVRs associated with said subset of said subscribers are leased from a service provider.

11. A system for delivering video content to a plurality of subscribers, said system comprising:
a plurality of set top boxes in communication with a video distribution network;
a video server in communication with said video distribution network, said video server configured to deliver a multicast stream of video content over said video distribution network;
a database associated with said video server to maintain subscriber activity data, said database configured to receive information related to particular video content; and
a processor in communication with said database, said processor configured to process said subscriber activity data with respect to said information related to particular video content, said processor configured to generate a list of said subscribers likely interested in said particular video content, wherein said video server is operable to push said particular video content to a set of set top boxes associated with said list of likely interested subscribers.

12. The system of claim 11, wherein said video server is configured to check the available bandwidth capacity of the network lines associated with said list of likely interested subscribers.

13. The system of claim 11, wherein said information related to said particular video content is selected from the group consisting of title, genre, rating, release date, cast, director and producer.

14. The system of claim 11, wherein said set top boxes are DVRs.

15. A method of delivering video content, said method comprising the steps of:
storing data related to the viewing habits of a plurality of subscribers;
receiving a request for said video content from a subscriber;
determining other subscribers within said plurality likely interested in said video content;
streaming said video content to said other subscribers.

16. The method of claim 15 further comprising the step of storing said video content on electronic memory devices associated with said other subscribers.

17. The method of claim 16 further comprising the step of notifying said other subscribers that said video content is stored and ready for immediate viewing.

18. The method of claim 15 wherein said determining step process said data related to the viewing habits of a plurality of subscribers with respect to information related said video content.

19. The method of claim 18, wherein said information is selected from the group consisting of title, genre, rating, release date, cast, director and producer.
